(19) United States
(12) Patent Application Publication
(10) Pub. No.: US 2004/0005183 A1
(43) Pub. Date: Jan. 8, 2004

(54) Low-aspect ratio keyboard

(76) Inventor: Scott MacFarlane, Manlius, NY (US)

Correspondence Address: Scott MacFarlane, 4677 Watch Hill Road, Manlius, NY, 13104, US

(21) Appl. No.: 10/189,882

(22) Filed: Jul. 4, 2002

(51) Int. Cl. B41J 5/10

(52) U.S. Cl. 400/472

(57) ABSTRACT

The present invention is a keyboard in which the aspect ratio of the keyboard, front to back relative to the side to side dimension is significantly less than that of current keyboards which is achieved by staggering the heights of the rows of keys from front to back to give a users fingers additional clearance. Other methods of enhancing typability on small and miniature keyboards is also disclosed.

### CROSS-REFERENCE TO RELATED APPLICATION

This application claims priority to U.S. Provisional Patent Application 60/302,895, filed on Jul. 2, 2001.

### BACKGROUND

The present invention generally relates to keyboards or keypads for electronic devices, and more particularly to compact keyboards or keypads for electronic devices.

Keyboards and keypads are the most popular means for the entry of data into electronic devices pointer-enabled data entry (e.g. a mouse a drop-down menu or a virtual keyboard), two other popular means of data entry, keyboards and keypads remain the most commonly used data entry devices for most electronic devices, including desktop computers, laptop computers, handheld computers, electronic books (ebooks), cell phones, calculators, personal information managers (PIMs) and personal digital assistants (PDAs). Even some of the popular handheld computers and PDAs that were originally designed for keyboardless data entry, have recently been offered in models which incorporate a miniature keyboard. In a related development, manufacturers of accessories for these devices have begun to sell keyboard peripherals (i.e. separate keyboards which can be attached to an electronic device) for portable electronic devices.

Keyboards are currently designed under a single paradigm (keyboard and keypad are used interchangeably herein). Under this paradigm, keys are supposed to be operated by pressing a finger down full upon their centers. Thus all keyboards share as a design feature key design and arrangement on the keyboard to facilitate actuation by downward force on the center of the key with a finger tip. This design feature of keyboards is shared by full-size desktop computer keyboards, by miniature keyboards for handheld computers and PDAs, by calculator and pocket organizer keyboards, by appliance keypads, by phone and telephone keypads, and even by collapsible and folding keyboards Keys on keyboards and keypads are spaced to prevent multi-key actuation, and keyboards and keypads of the prior art are designed so that the distance from the center of one key to the closest part of any adjacent is approximately equal. This constrains these keyboards to an aspect ratio of between three-quarter (3:4) and one (1:1). The aspect ratio of a keyboard is the ratio of the distance from between the closest edges of keys in a first row and a second row that are separated by a third row to the distance between the closest edges of a first key and a second key in the same lateral row that are separated by a third equal sized key (a standard sized key such as a letter key). Thus on a standard keyboard for a desktop computer the aspect ratio is one (three-quarters of an inch by three-quarters of an inch which corresponds to the size of an average adult finger tip), on the keyboard of the portrait view Blackberry 5810 and the landscape view Blackberry RIM 950 pagers it is about 6:5, on the Handspring Treo 270 PDA cell phone it is about 7:8, on the Palm, Inc. Palm Mini Keyboard it is about 1:1, on the new Sony Clie NR70V it is 4:3, on the Sharp Zaurus SL-5500 it is about 6:5, and on the Sharp Wizard YO180 about 5:6. Since the fingertip has a slightly low aspect ratio of about 5:6 to 7:8, it is worse to have a high-aspect ratio than a 1:1 aspect ratio.

An aspect ratio of approximately 1:1 makes sense if a user is intended to actuate the keys by pressing on their center with a finger because it equalizes the clearance between the target key and adjacent keys in all directions. If one reduces the aspect ratio of present keyboards, one must be more and more careful to avoid striking multiple keys.

However, it severely constrains the range of possible keyboard sizes and shapes.

The underlying rule governing the design of prior art keyboards that the aspect ratio of the keyboard must be about 1:1 has prevented keyboard designers from designing keyboards with aspect ratios much less than 1:1. It is, however, sometimes desirable to have keyboards with an aspect ratio significantly lower than one. For example, an aspect ratio of one means that a keyboard that is three inches wide (such on the Blackberry 8510, the Handspring Treo and the Palm Mini Keyboard) will be roughly one inch deep (front to back). On a typically sized PDA or handheld computer, one inch is roughly one-quarter of the usable surface area, the rest is occupied by the display and the handwriting data entry touch pad. Although users might prefer a larger screen, the size of the display cannot be increased without either eliminating the keyboard, the handwriting data entry touch pad (as is done on the Handspring Treo combination PDA-cell phone) or shrinking the depth of the keyboard. Moreover, some cell phones with integrated PDA functionality have screens viewed in landscape orientation with the cell phone held sideways. There is no room for a keyboard of current design because there is only about one-half inch of space between the screen and the edge of the case. Given current design, a keyboard ½″ in depth would be 1.5 inches in width, far to small for use There are those who would prefer their handheld computers to have a landscape orientation, but again, a conventional, 1:1 aspect ratio keyboard could not be added to handheld computers with a standard-size display in landscape orientation without increasing the width dimension of the devices beyond the three inches that fits in a standard shirt pocket. And electronic devices continue to shrink in size.

Some devices, such as tablet computers and ebooks are primarily portable display screens, and keyboards for these devices must be particularly compact and unobtrusive. A very shallow or low-aspect ratio keyboard along the bottom edge of the device might be a valuable addition, but current keyboard design makes this impossible to implement. Devices such as a pen computer cannot accommodate a keyboard with an aspect ratio of one; they can only accommodate a very shallow keyboard. Other electronic devices such the computer mouse or game input devices (e.g. a joystick) for games that call for text entry could incorporate a low aspect ratio keyboard, but would have difficulty accommodating a standard design keyboard with an aspect ratio of one. MP3 players would be improved by the addition of a keypad or keyboard for data entry and conducting searches, but conventional 1:1 aspect ratio keyboards are too big. Keyboards for Internet kiosks are a problem because they stick out so far from the structure in which the kiosks are typically embedded; a low aspect ratio keyboard would work better. For the new car computer entertainment systems, a standard design keyboard will either be unobtrusive, but too small to be easily used, or big enough to use relatively easily, but large and obtrusive. Again, a low aspect ratio keyboard would be preferred.

Furthermore, small and miniature keyboards not only have an aspect ratio of approximately 1:1 which limits their variety, but the are also flat. Because they are flat it is harder to distinguish between keys and it is easier to hit more than one. Almost as detrimental to usability, on flat miniature keyboards a user's finger obscures quite a few keys from view when typing, which makes it difficult for a user to see where and what he or she is pressing. Because the user presses the keys in their center, the ability to see keys in all directions from the target key are obstructed (on a BlackBerry keyboard, an adult thumb obstructs the view of all or part of seven to ten keys, including the target key the user intends to actuate). To mitigate the problem of hitting multiple keys at a time, some electronic devices use algorithms to guess which of the several keys pressed by the user is the key the user meant, but this is at the price of complexity, power consumption and CPU bandwidth. Unfortunately, those algorithms do not solve the problem of the finger obscuring multiple keys, nor do they always guess the correct key.

### DISCLOSURE OF THE INVENTION

It is the object of the present invention to overcome the drawbacks of constraining keyboards to (1) layouts with an aspect ratio of approximately 1:1 and (2) layouts in the two dimensions of width (side to side along the rows) and depth (back of the keyboard to the front). It is the object of the present invention both to make small and miniature keyboards with a 1:1 aspect ratio more usable and to create new low-aspect ratio keyboards for multiple applications and devices. FIGS. 1A and 1B demonstrate the advantage of a keyboard in which rows are at different heights. FIG. 1A is a side view of a flat, miniature prior art keypad with three rows of keys. The user is using his finger 13 to actuate the key in the middle row 11, but because the key depth 18 is so small, the user's finger 13 overlaps and may actuate the keys 10 & 12 in the adjacent rows. FIG. 1B is a keypad of the present invention with rows of different heights. The user is using his finger 13 to actuate the key in the middle row 15. Because there is a sufficient height differential 19 between the key in middle row 15 and the key in the first row 16, there is clearance 17 between the finger 13 and the key in the first row 16 and the user only actuates the intended key. The height differential 19 also allows the user to press the edge of the key in the middle row 15 rather than its center which keeps his finger 13 from actuating a key in the last row 14 to the back. This simple set of drawings clearly illustrate why, for any size keyboard, but especially for small and miniature keyboards, a height differential between rows enhances the keyboard's usability, and why the keyboards of the present invention which incorporate such a height differential between rows are superior to conventional, prior art keyboards.

Note that in the following text and drawings, the QWERTY alphanumeric keyboard (which, unless otherwise indicated, will be what is meant hereinafter by the word keyboard) is often used as the example, but everything that is said about QWERTY keyboards applies to any keyboard or keypad with at least two rows of keys containing at least two keys in each row. The following also refers frequently to electronic devices such as handheld computers, PDAs, pagers, cell phones and laptops, but it also applies to any electronic device with, or that could have, a keypad for entry, such as a calculator, entertainment device (e.g. radio and MP3 player) and even a kitchen appliance into which data can be entered.

It is an object of the present invention to improve the type-ability of small and miniature 1:1 aspect ratio keyboards by introducing a vertical height differential between rows of keys that increases the physical separation of keys in different rows and by altering the cross-sectional shape of the keys so that the perceived and effective physical separation of keys in the same row is likewise increased. Type-ability of small and miniature keyboards of the present invention is improved because in operation the user's finger obstructs fewer keys than are obstructed on a prior art keyboard of the same size, and because it is easier to avoid inadvertent actuation of multiple keys.

It is another object of the present invention to introduce keyboards with an aspect ratio of significantly less than 1:1 for inclusion in a variety of electronic devices. These include extremely low-aspect ratio keyboards (1:3, 1:4 or even lower) for devices such as: peripheral keyboards that are easier to carry and store because they are narrow, but are wide enough for easy typing; keyboards that can be incorporated into the edge of ebooks and tablet computers so that display screen area is not lost; keyboards for radios, TVs, set-top boxes, remote control devices and other electronics for entertainment; smaller keypads for cell phones, especially for those without a handset; keyboards for incorporation in cell phones and handheld computers below a landscape-oriented display screens; keyboards for pen-type computers; keyboards for computer kiosks that stick out from the kiosk one-half, one-third or even one-quarter as much as a standard aspect ratio keyboard yet have full width, easy to utilize keys; keyboards for future portable computers which have flexible display screens that fold or roll up so that these future computers are not constrained in size to that of the keyboard; and many other varieties of keyboards for a multitude of electronic devices.

The keyboards and keypads of the present invention can be incorporated directly into an electronic device or be designed for use as a peripheral for an electronic device. The present invention can be a keypad of any type and key layout, including, but not limited to alphanumeric keyboards, number pads, calculator keypads, and telephone dial pads. Any reference herein to a keypad or keyboard can apply to any keypad consisting of more than one row of keys, each row consisting of at least two keys. The keyboard of the present invention can be of any width, from full-size to miniature. The keys can be set into a sloping housing, mounted in a series of steps in the housing, or the keys can just be progressively taller to create ever higher rows. Keys can have vertical front edges that butt up against or are adjacent to the back edge of the keys in the row below, or the keys can overhang keys in row below. The keys can be square, triangular, oblong, diamond or any shape that is appropriate.

It is another object of the present invention to enable the creation of keyboards with more rows than a standard desktop computer keyboard. By reducing the aspect ratio of the keyboard, a keyboard can have more rows of keys without an increase in the size of its footprint. A reduction of the aspect ratio by a factor of 2 would allow a doubling of the number of rows within the 4.75 inch deep footprint of a full-size keyboard from six to twelve rows. Such a keyboard would be extremely useful for non-alphabet languages such as Japanese and Chinese and for languages with many more than 26 letters. These multilevel keyboards with extra rows could also be useful for scientists using frequent symbols, musicians, graphic artists and any other application that frequently uses more characters than those on a standard 101-key keyboard.

It is another object of the present invention to provide for keyboards built into a sloping side of an electronic device, such as in the end of a handheld computers or a PDA. The 0.7 inch depth of many of these portable devices provides sufficient room for a keyboard of the present invention.

It is another object of the present invention to provide keyboards that can be operated in either single level (i.e. like existing keyboards) and multilevel modes. Keys of such a keyboard are constructed such that they have a point or edge oriented upwards when in flat single-level mode and to have a flat surface oriented upwards when in multilevel mode. The switch for single-level mode to multilevel mode can be accomplished either by tilting the keyboard separately or by tilting the entire device of which the keyboard is a part.

It is a further object of the present invention to provide a small or miniature keyboard that allows easy typing with both a finger and a stylus.

It is a further object of the present invention to provide a new key design for keyboards with a height differential between the rows.

### BRIEF DESCRIPTION OF THE DRAWINGS

FIG. 1A is a drawing of a finger typing on a flat miniature prior art keypad.

FIG. 1B is a drawing of a finger typing on a miniature keypad of the present invention.

FIG. 2A is a side view of a keyboard of the present invention wherein the height differential is created by a stepped substructure.

FIG. 2B is a perspective view of the keyboard of FIG. 2A.

FIG. 3A is a side view of keyboard of the present invention with cantilevered key tops and pivoting key actuation.

FIG. 3B is an exploded perspective view of the keyboard of FIG. 3A.

FIG. 4A is a side view of a keyboard of the present invention with pivoting keys that is appropriately used in both an inclined orientation and in a flat orientation. The keypad is shown in the inclined orientation.

FIG. 4B shows the keypad of FIG. 4A in the flat orientation.

FIG. 4C is an exploded perspective view of the keypad of FIG. 4A.

FIG. 4D is the keypad of FIG. 4A built into a keypad assembly along the side of a portable electronic device in the stored position vertically against the side.

FIG. 4E shows the keypad of FIG. 4D in the open inclined position for use.

FIG. 5A shows several options for key shapes for a keyboard with the cantilevered key tops shown in FIG. 4A.

FIG. 5B is a view from under a keypad which incorporates the cantilevered keys shown in FIG. 4A with a key top in one of the optional shapes shown in FIG. 5A.

FIG. 6 is a top view of a miniature QWERTY keyboard with cantilevered key tops of the type shown in FIG. 4A and the shape shown in FIG. 5A as compared in size to a prior art keyboard of the same width.

FIG. 7 is a side view of a keyboard of the present invention wherein the key tops of the keys in each row are progressively thicker in vertical dimension.

FIG. 8A is a side view of a keyboard of the present invention in which the keys in one row are nested between the keys of the adjacent rows.

FIG. 8B is a top view of the nested keyboard shown in FIG. 8A.

FIG. 8C is a perspective drawing of a portion of the nested keyboard of FIG. 8A showing how the nesting of the keys combined with the vertical height differential between rows makes it easier to type on a miniature of this type using a stylus.

FIG. 9A is a top view of a low-aspect ratio peripheral keyboard of the present invention for use with a handheld computer.

FIG. 9B is a stylized side view of the peripheral keyboard of FIG. 9A showing the orientation of the keys relative to the connector.

FIG. 10A is a top view a keyboard of the present invention that is built into the side of a combination cell phone/PDA.

FIG. 10B is a stylized side view of the keyboard of FIG. 10A.

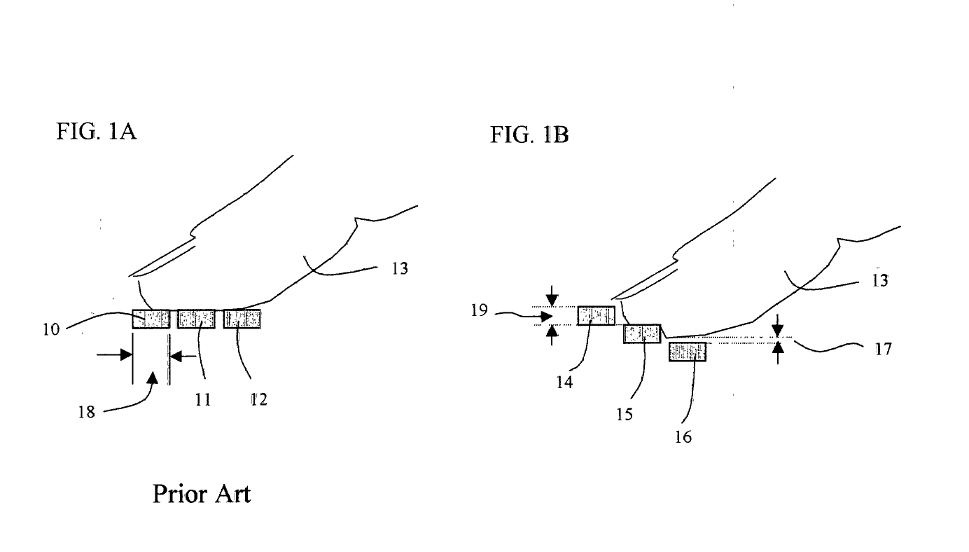

### DETAILED DESCRIPTION OF THE PREFERRED EMBODIMENTS

More particularly, the keyboards and keypads of the present invention comprise and set of at least four keys arranged in at least two rows of unequal height, the higher row(s) being further from the user when in use. The top surfaces of the keys are at an angle to the slope of the keyboard (from highest to lowest row). The keys are operated by pressing on the front edge of the key (the portion nearest the user). The vertical height differential between keys in one row and those in a lower adjacent row is sufficient to provide enough clearance that a finger pressing down on the front edge of a key in one row will not accidentally actuate a key in the lower row. The minimum height differential between rows should be between one-eighth to one-quarter inch to ensure that all but unusually large fingers have adequate clearance. Keys in one row can be directly in line with keys in adjacent rows, or they can be offset from each other.

The invention relates to a keyboard or keypad assembly. Specific details of an embodiment of the keyboard assembly are described below. Numerous specific details including keyboard layouts, specific structural arrangements and relationships, etc. are presented in order to provide a thorough understanding of the invention. It is to be appreciated that these specific details need not be specifically employed to practice the invention and that there are other details that are not presented so as not to unnecessarily obscure the description of the invention that may be substituted or included that fall within the scope of the claimed invention.

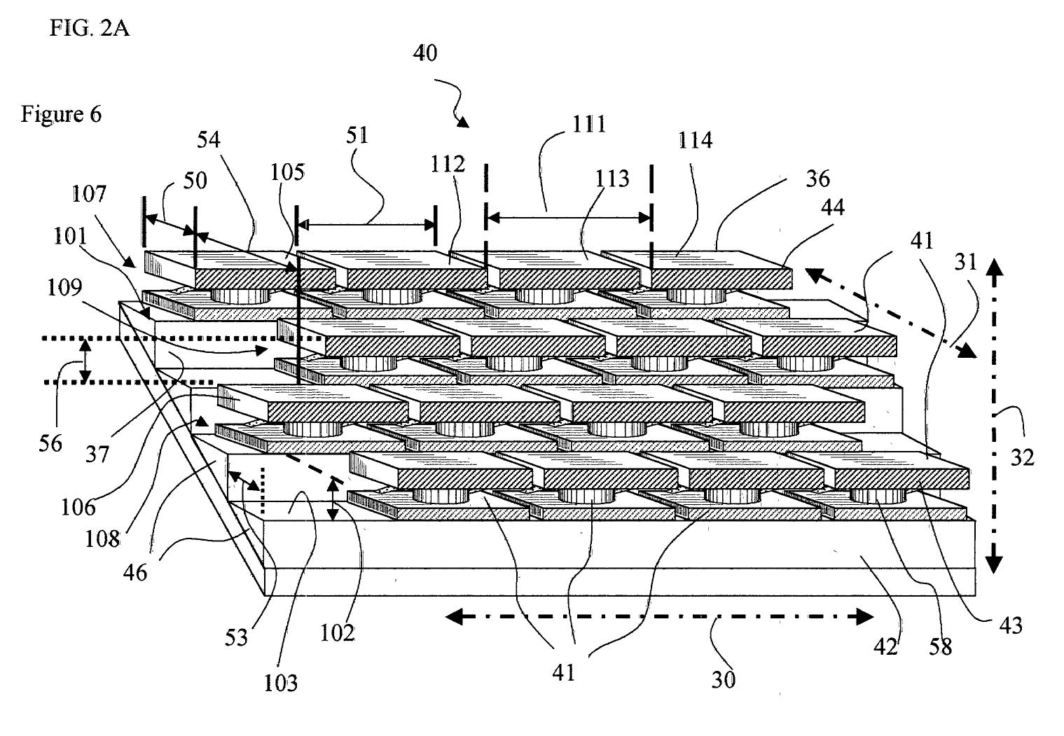

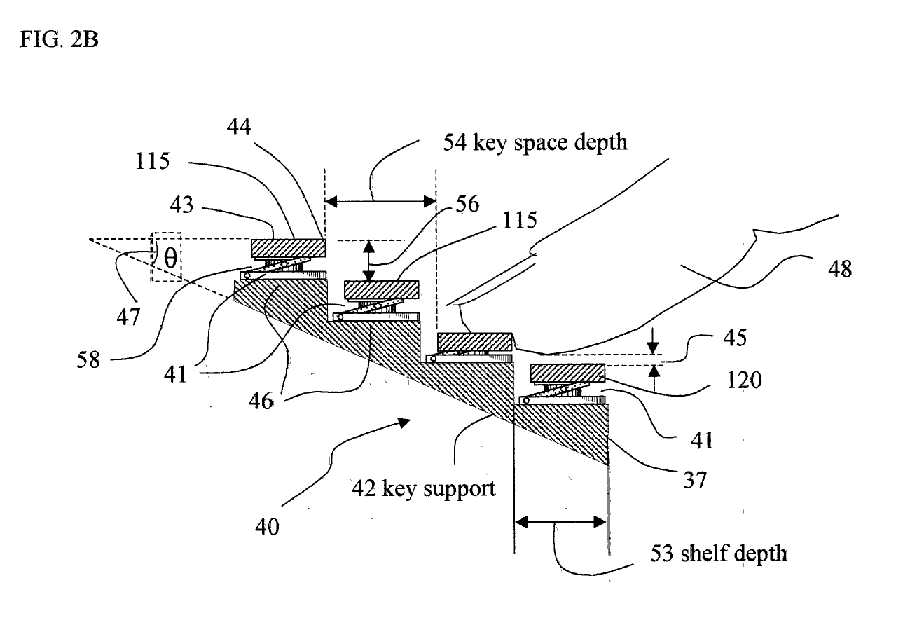

FIGS. 2A & 2B are different views of the keypad 40. FIG. 2A is a perspective view of a preferred embodiment of the keypad of the invention. The keypad 40 of FIG. 2A comprises a key support 42 of stepped construction having arranged upon it sixteen key assemblies 41. The keypad 40, and all other keypads and keyboards of the present invention, has a first lateral axis 30 (from side to side), a second longitudinal axis 31 (from the front of the keyboard to the back), and a third vertical axis the leading edge 44 of a first key 105 in a first row 107 to the trailing edge 36 of a second key 106 in a second lower row 108 that is separated from the first row 107 by a single intervening row 109 to the lateral distance 111 from the right edge of a first key 112 disposed to the left of a second key 113 to the left edge of a third key 114 situated to the right of the second key 113. The aspect ratio of the keypad 40 is one-half but it could be less or more. The key support 42 has a first side 39 (not visible) and a second side 101. The second side 101 of key support 42 is formed into four laterally parallel steps 46 of equal longitudinal dimension 53 and vertical rise 102, and having a vertical front face 37, and a horizontal top surface 103. Affixed at equal intervals laterally along the top surface 103 of each step 46 are four key assemblies 41 consisting of a key top 43 and a key actuator assembly 58. Key assemblies 41 in one row are offset from those in adjacent rows by half the distance from the centers of two keys in the same row. Pressing down on the key top 43 of a key assembly 41 actuates the key actuator assembly 58 and generates an electronic signal. Key tops 43 have a leading edge 44 and a trailing edge 36, and a longitudinal dimension 50 and a lateral dimension 51. The key actuator assemblies 58 are connected to a wiring layout (not shown, but which will be obvious to those skilled in the art as it sill differ only superficially from existing wiring layouts) which can either be situated on first side 39 of support 42 or on the second, stepped side 101 of key support 42.

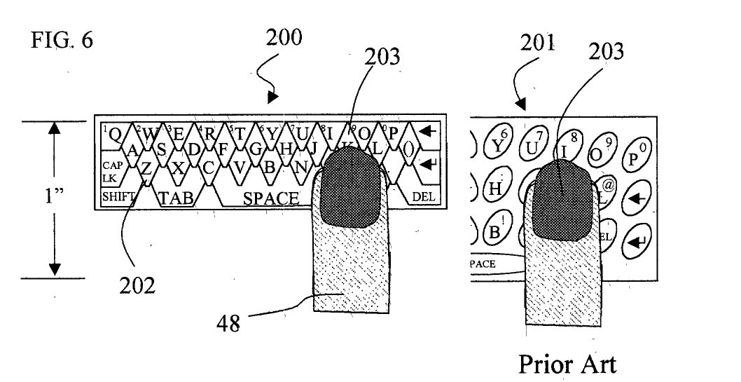

The embodiment of the invention in FIG. 2A is not a particular type of keyboard or keypad, but rather preferred way to construct a multi-level keypad of the present invention having a vertical height differential 56 between the lateral horizontal plane of the keys in one row and that of an adjacent row. It is intended to be built into a housing with other components necessary to create a standalone keypad or into the housing of an electronic device. The basic components of the keypad in FIG. 6 can modified to create keypads and keyboards of any type, including alphanumeric keyboards, telephone keypads, calculator keyboards, and many more.

This embodiment is advantageous because the keypad 40 is of FIG. 2A & 2B is easy to produce, consisting of readily available components already used in existing keypads and keyboards (since in operation the key assemblies 58 still have a vertical axis. The keypad 40 differs from current keyboards by (1) addition of a shelf to change orientation of the plane of each row of keys from approximately tangential to the board supporting the keys to inclined relative to the board supporting the keys, (2) by the angle of keyboard support relative to the plane of the keys, and (3) by its low-aspect ratio. In operation, the keypad 40 of FIG. 2A & 2B would preferably be at an angle such that in use the plane of the tops of the keys in each row is roughly horizontal, although some users may prefer a different angle of use. An advantage of the design of the keypad 40 in FIG. 2A is that because the key assemblies 41 have the same vertical axis that a prior art keyboard does, it can be assembled using the key mechanisms of any prior art keypad with the same footprint and layout (because the steps 46 have a vertical face 37, the combined area of the top surfaces 103 of the steps 46 is that of a prior art keyboard with the same lateral and longitudinal dimensions as the keypad 40), provided, however, that the key tops are sufficiently stable that force applied to their front edge will actuate the key and that the shape of the key tops provides a relatively distinct leading or front edge.

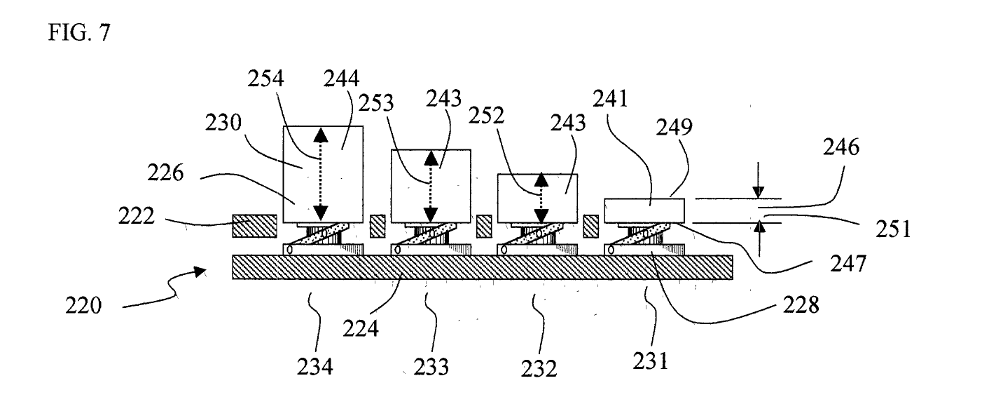

FIG. 2B is a side view of the keypad of FIG. 2A. The plane of the top surface 103 of the steps 46 is at an angle theta 47 to the plane of the bottom side of key support 42 and creates a vertical height differential 56 between the top surfaces 115 of two adjacent rows of keys. The leading edges 44 of the key mechanisms 41 are aligned with the rising face 37 of the steps 46. The vertical difference 56 between the heights of adjacent rows must be enough that there is a positive clearance 45 between the user's finger 48 and the adjacent key in a lower row 120. The key mechanism 41 can be any key mechanisms used in a touch-typable desktop or laptop keyboards provided that key top 43 is sufficiently stable that force applied to the leading edge 44 of the key top 43 will actuate the key mechanism 41 and not substantially deform or tilt the key top 43. The longitudinal dimension of the steps 46 is no larger than the longitudinal dimension of the key top 43. Note that finger 48 deforms somewhat on contact with key top 43. The key front edge 44 in the keypad of FIGS. 6 and 7 is a right-angle, but key front edge 44 can also be sloped or concave or any other shape that does not overly reduce or eliminate all together clearance 45. Preferable key front edge form will enhance the keypad user comfort or keypad usability without significantly effecting finger clearance 45 while in use.

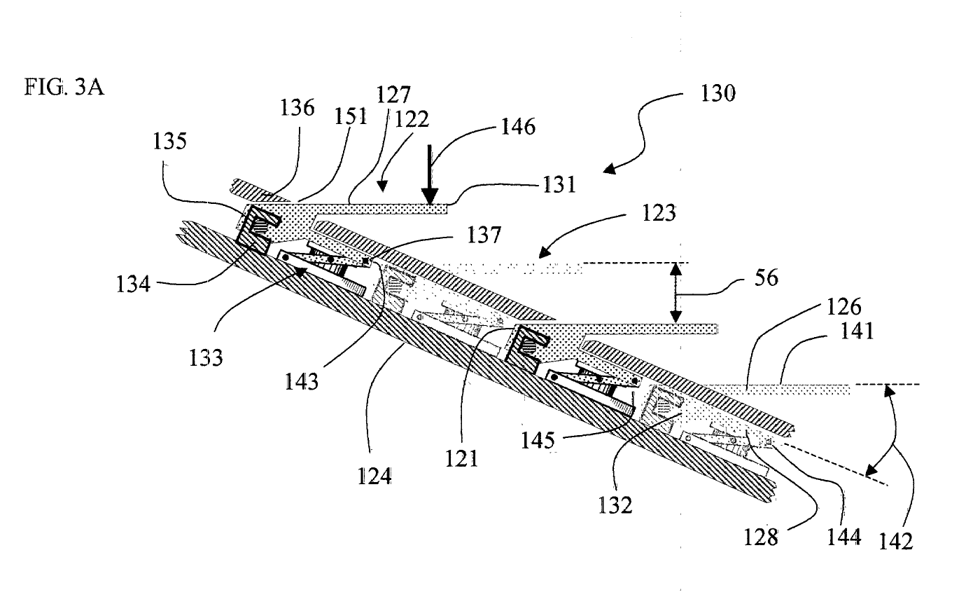

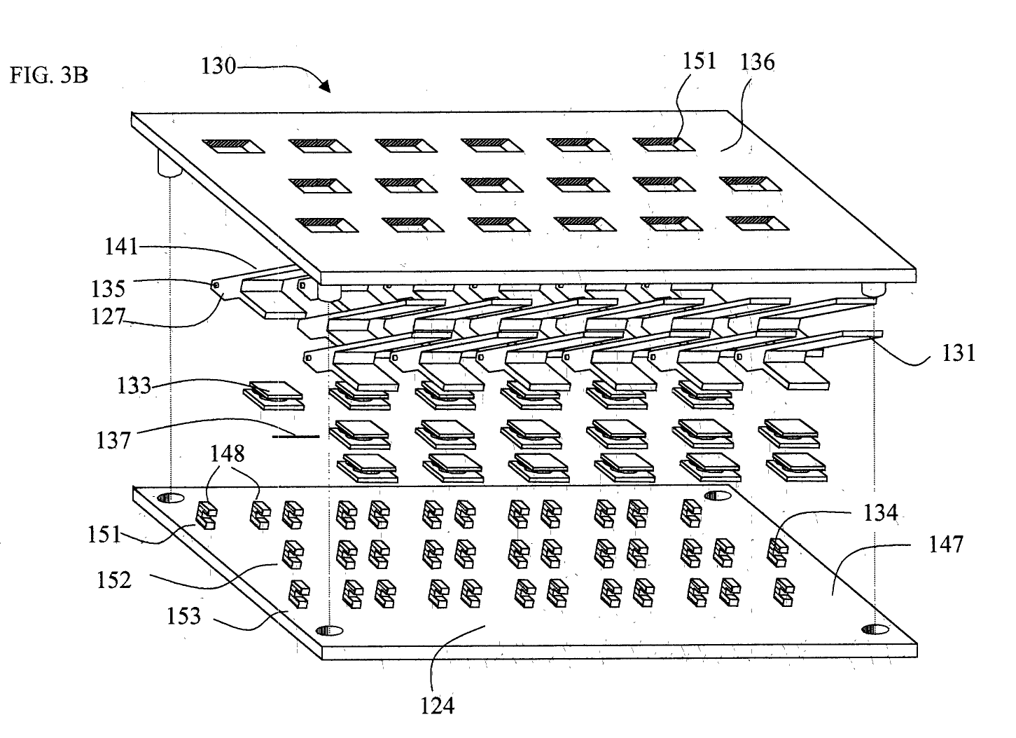

FIG. 3A shows a partial side view of another embodiment of the invention. In this keypad 130, the leading edge 131 of the key top 127 of a key assembly 129 in a first row 122 of keys extends substantially beyond the trailing edge 121 of the key top 127 and of the key assembly 129 in a second, vertically lower row 123 of keys. Unlike the embodiment shown in FIGS. 2A & 2B, in the keypad 130 shown in FIG. 3A & 3B the key support 124 is substantially flat on both sides (i.e. no steps). The key top 127 is shaped to perform the same function that the steps 46 performed in the keypad 40 of FIG. 2A & 2B; it creates an angle between the plane of the keys and the plane of the key support 124. The key top 127 is cantilevered over key actuator 133. The key top 127 has a first thin rectangular planar element 126 and a second thin and shorter rectangular planar element 128 that are longitudinally parallel and that are joined at a substantial elbow 132 at a vertical angle 142 to each other (the angle 142 is the same as the angle of the key support 124 to the horizontal plane). Projecting laterally from each side of the elbow 132 at the intersection of planar elements 126 & 128 are two pegs 135 which are engaged within a C-shaped bracket 134 on each side of the key assembly 129 which is molded into or attached fixedly to the key support 124 and which creates a pivot point around which the key top 127 can rotate on an axis parallel to the lateral axis of the keypad 130. The first planar element 128 projects through a slot 151 in the optional keypad cover 136 and extends parallel to the longitudinal axis of the keypad 130 and the top surface 141 of the key top 127 is horizontal. The leading edge 144 of the shorter of the two planar elements 128 is pivotably attached by a lateral pin 137 to the leading edge 145 of the key actuator assembly 133 creating a pivot point around which the key top 127 can rotate on an axis parallel to the lateral axis of the keypad 130.

The key actuator assembly 133 is of the same construction as that on an IBM A20m ThinkPad laptop computer and is designed so that application of a force to its leading edge 145 will actuate the key and generate an electronic code such as an ASCII code. Other types and manufactures of keys will also work and it will be obvious to one skilled in mechanical and keyboard design how to implement them in the keypad 130. Application of a downward force 146 to the leading edge 131 portion of the first planar element 126 of the key top 127 applies a force to the second planar element 128. Because the leading edge 131 of the first planar element 126 is cantilevered past the pivot point formed by the pin 137 at the leading edge 144 of the second planar element 128, the pin 137 will form a fulcrum and an upward force will be transferred to the trailing edge 121 of the key top 127 which will in turn push the peg 135 against the upper part of the bracket 134 and transfer a downward force to the key actuator assembly 133 causing it to depress and actuate. Many other designs of a key mechanism that will transfer force from cantilevered first planar element 126 to key actuator assembly 133 will be obvious to designers of mechanical devices.

FIG. 3B shows an exploded view of the keypad 130 of FIG. 3A. It is intended to be oriented so that the top surface 141 of the key tops 127 are horizontal when in use, although different users may have different preferences. This embodiment is not a particular type of keypad or keyboard, but a structure that can be used for keypads or keyboards for any application, such as for a desktop keyboard, a telephone number pad or a calculator The electronics (not shown) can be on either side of key support 124, or could be on a separate board to which key actuator assemblies 133 are wired. It will be obvious to any skilled in the art of keyboard design how to construct the electronics for the keypad 130, and in fact it may be possible to use the key support 124 and key actuator mechanism 133 assembly from a prior art keypad with the same footprint. Eighteen key actuator assemblies 133 are mounted on the top surface 147 of the key support 124 in first 151, second 152 and third 153 laterally extending parallel rows of six equally spaced key actuator assemblies 133. The first and third lateral rows 151 & 153 are aligned longitudinally, and the second lateral row 152 is offset from the first and third lateral rows 151 & 153 by approximately one-half the distance between the center points of two adjacent keys in the same row. The rows 151, 152 & 153 are offset longitudinally by a distance which is a function of the angle 142 (see FIG. 3A) and the desired footprint (the longitudinal and lateral dimensions only) and layout of the keypad.

Pairs of c-brackets 134 are arrayed on the top surface 146 of the key support 124 in an identical arrangement, with the two brackets 134 centered around a longitudinal axis bisecting the key actuator assembly 133 and offset longitudinally by a distance determined by the size and construction of the key tops 127. The two brackets 134 of each pair of brackets 148 are separated by a lateral distance slightly greater than the lateral dimension at the trailing end 121 of the key tops 127 so that it moves freely therebetween. The pegs 135 of the key tops 127 are inserted into the c-brackets 148 and the leading edge 144 of the second element 126 of each key top is pivotably attached to the leading edge 143 of one of the key actuator assemblies 133 using a pin 137. The leading edges 131 of the key tops 127 are threaded through the key slots 151 in the optional cover 136. Other designs of key tops 127 are easily within the capability of one skilled in the art. The key actuation mechanism 133 can be of any kind, including a membrane switch.

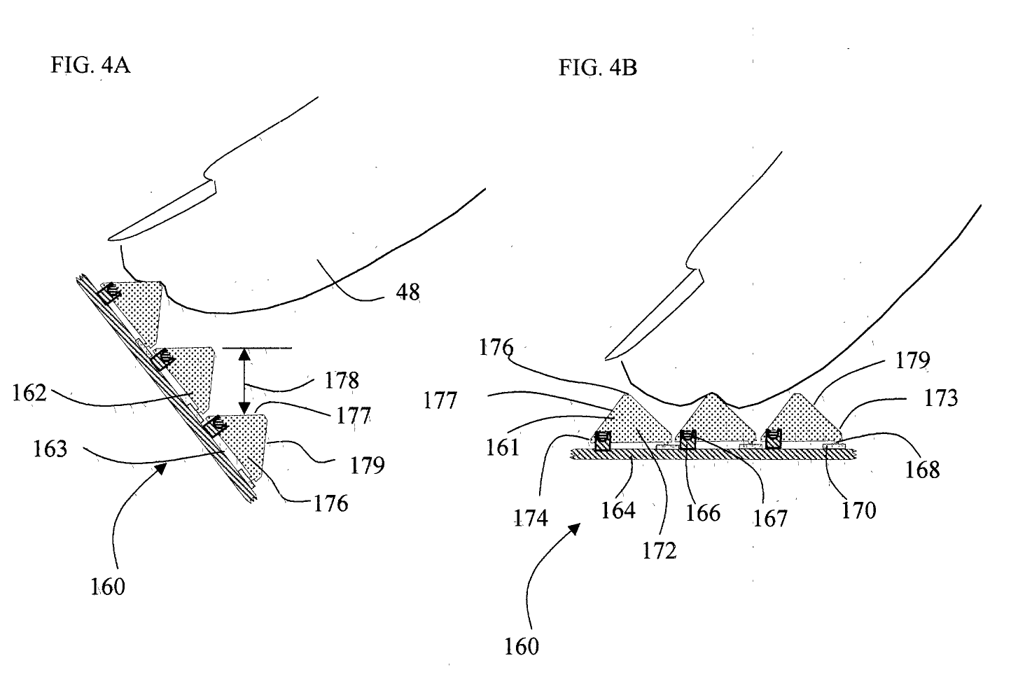

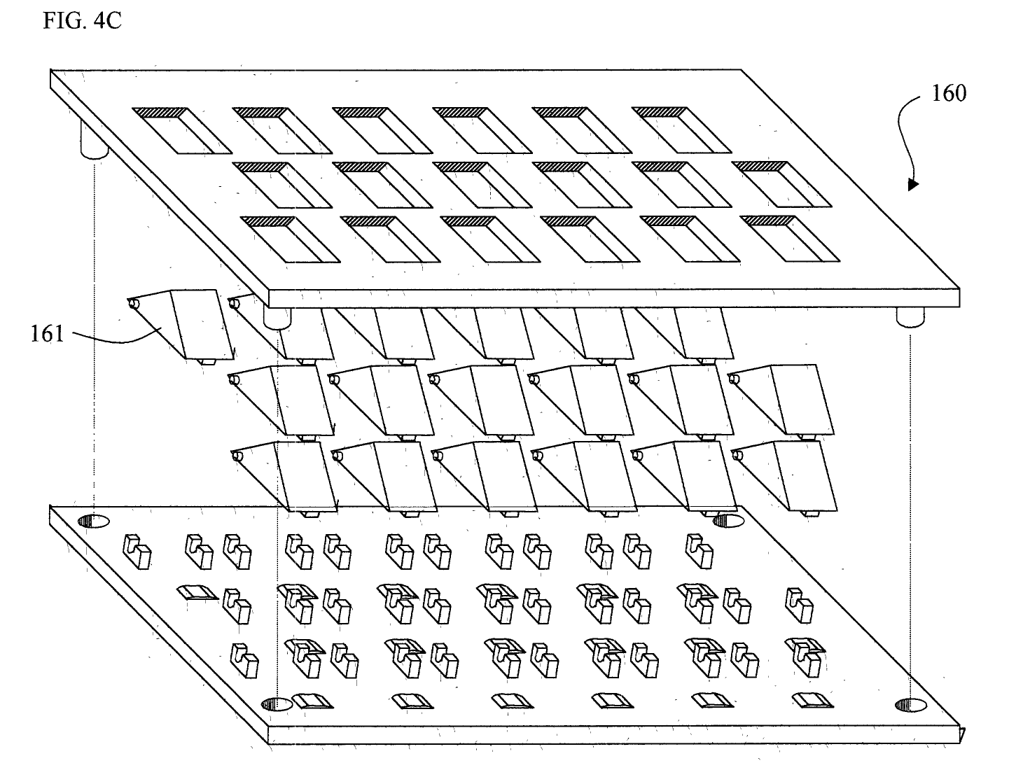

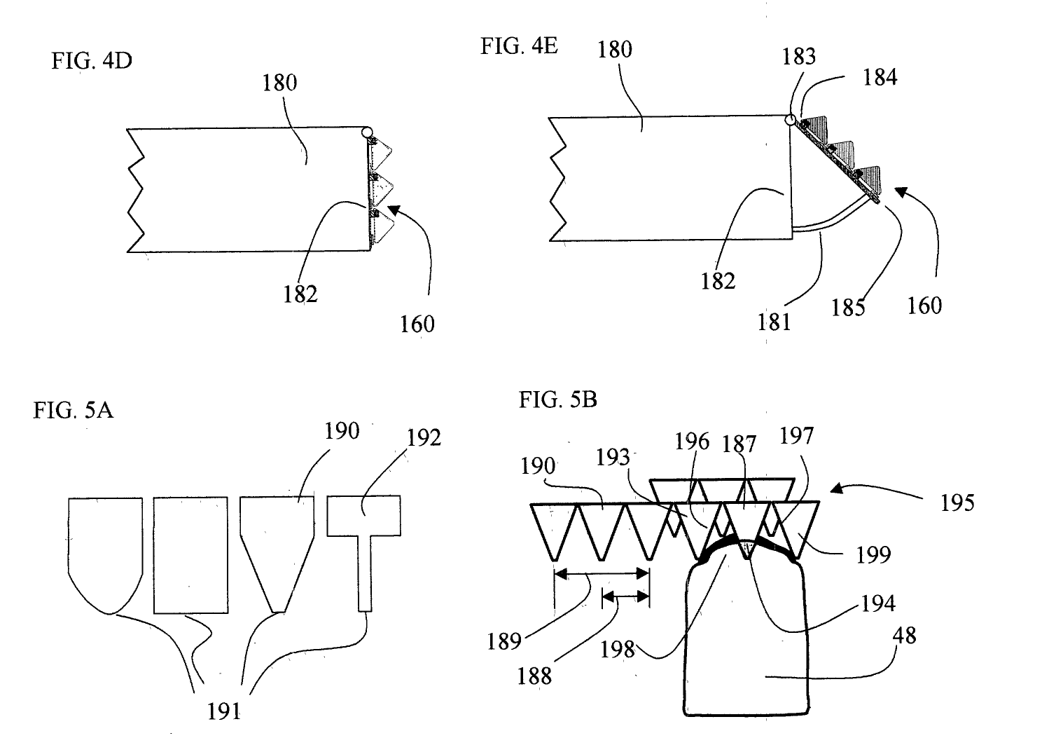

FIGS. 4A, 4B & 4C show different views of a keypad 160 that is very similar to the keypad 130 of FIGS. 3A & 3B, differing primarily only in the type of key top. The key top 161 is not a cantilevered key but is shaped instead like an extruded triangle with slightly flattened corners 171. The key top 161 is oriented with the triangle-shaped sides orthogonal to the lateral axis of the keypad 160. Pivot pegs 167 extend laterally from the triangular sides 172 at the trailing edge 174 of the key top 161 and when the keypad 160 is assembled the pegs 167 are pivotably engaged in the brackets 166 such that the key top 161 can pivot around the pegs 167 in a longitudinal arc. At the leading edge 173 of the key top 161, a nub 168 protrudes downward and is in contact with a membrane-type key actuation mechanism 170 (other key actuation mechanisms will also work such as the key actuation mechanism 133 of the keypad 130 of FIG. 3A). In some embodiments, the key top 161 can be attached to the key actuation mechanism 170 and there can be springs to provide the touch typing feel. FIGS. 4A, 4B & 4C are not detailed but the operation and design of the keypad 160 will be obvious to one skilled in the art after the detailed description given of the keypad 130 of FIGS. 3A & 3B. Because of the pivoting design of the key mechanism of the keypad 160, no matter whether the keypad 160 is inclined (as shown in FIG. 4A) or flat (as shown in FIG. 4B) pressing down the key activation edge 176 of the key top 161 will cause the key top 161 to pivot around the pegs 167 in the brackets 166 and will cause the nub 168 to actuate key actuation mechanism 170. Thus, the keypad 160 has the additional advantage that it can be operated in both an inclined orientation where there will be a vertical differential 178 between the trailing face 177 (now oriented facing upwards) of the key top 161 of a key in a first row 162 and the trailing face 177 of the key top 161 of a key in a second, lower row 163.

The key top 161 has an additional advantage when it is in use in the flat orientation shown in FIG. 4B. The triangular shape of the key top 161 when the key activation edge 176 is oriented vertically accentuates the tactile sensation of the key and makes it easier for a user to feel the key and differentiate it from other keys. It also increases the effective distance between keys in the longitudinal direction. An alternate embodiment has a key top 161 that is shaped like a pyramid and the key activation edge 176 becomes a point, which has the effect of increasing the effective physical distance of a particular key from all adjacent keys, whether in the inclined or flat orientation.

FIG. 4C shows an exploded perspective view of the keypad 160 and is self-explanatory to one skilled in the art of keyboard design after reading the description accompanying FIG. 3B. The wiring of the keys is not shown but will be obvious to one skilled in the art. It will be clear to one skilled in the art after a moments reflection, that since the actuation of the keys occurs approximately orthogonal to the key support 164, the key actuation mechanism 170 can be any of the many key actuation mechanisms used in prior art keyboards and the wiring layout can be the same. In fact, a prior art keyboard can most often be converted to the dual orientation keypad of FIGS. 4A, 4B and 4C simply by substituting a different key top for the prior art key top. Prior art key tops, however, are designed for actuation by a finger tangential to the key top, and are therefore inappropriate for dual orientation use. The perspective view of the key top 161 is shown. In FIGS. 4A & 4B, a finger 48 is shown pressing a key for illustrative purposes. The keypad 160 can be integrated into any electronic device (such as a handheld computer) such that the keyboards orientation is changed by rotating the device around a lateral axis, or it can be incorporated into a keyboard assembly of that device that has at least two stable positions: inclined and flat. On some devices it may be desirable to have the keypad along the side of the device in an assembly that can be rotated into an inclined or even flat position.

FIG. 4D shows the keypad 160 in the stored state against the side or end 182 of a handheld device 180 and FIG. 4E shows the keypad 160 lifted away from the side or end 182 and into an inclined position for use. The keypad 160 pivots around a hinge 183 by which it is attached at its back edge 184. On the underside of the keypad 160 near its front edge 185, a support arm 181 is attached. The support arm 181 retracts into a channel (not shown) the housing of the device 180 and has at least two stable positions: the fully retracted position for keypad storage shown in FIG. 4D and a partially extended position shown in FIG. 4E that holds the keypad 160 in an inclined orientation for use. The accomplishment of this adjustable leaf (as in a table leaf) structure and the electronic connection of the keypad 160 to the device 180 will be simple for one skilled in the design of mechanical devices and keyboards.

FIG. 5A shows four of the many options for the shape of the key top 127 for use with the cantilevered keypad 130 shown in FIGS. 3A & 3B. The key leading edges 191 are the portion of the key top that will be oriented towards the user and with which the user's finger will be in contact. Note that it is the narrowest part of the key tops 190 and 192. By narrowing the leading edge 191 of the key tops 190 & 192, the effective distance between two adjacent keys in the same row is increased and the tactile distinctness of individual keys is enhanced.

FIG. 5B is a view from underneath a keypad 195 to illustrate the interaction between a finger 48 and the key top 190 of FIG. SA. This is an unrealistic view in that none of the structures that would normally obstruct this view have been included. Note that because the closest edges 196 & 197 of the adjacent keys 193 & 199 are inclined away from the longitudinal axis of the key 187 being pressed, the effective separation distance 189 (i.e. between the closest edges of first and second keys separated by a third key in the same row) between the key 187 and the adjacent keys 193 & 199, and therefore the space available for the tip 198 of the finger 48, is increased. The effective separation from one key and its neighbor is the distance 188. The tip 198 of the finger 48 is able to press on the key top 190 at the point of contact 194 without touching the adjacent keys 193 & 199. If the key tops of the keypad 195 were instead the key tops 127 of FIG. 3A & 3B, the tip 198 of finger 48 would not be able to press the key 187 without also pressing the adjacent keys 193 & 199.

FIG. 6 is a top view of a miniature low-aspect ratio alphanumeric keyboard 200 having cantilevered key tops 202 of the cross-sectional shape 190 shown in. FIG. 5A & 5B having the construction of the cantilevered key keyboard shown in FIGS. 3A & 3B. An illustration of a section of a prior art keyboard 201 is included to emphasize how much the decrease in the aspect ratio from approximately 1:1 to 1:2 makes in the size of the keyboard 200. A finger 48 is shown typing a letter “K” key 203 on both the keyboard 200 of the present invention and the miniature prior art keyboard 201 (found on Blackberry and Handspring PDAs and on the Palm Mini Keyboard peripheral) to show how much better the visibility of the keys is on the keyboard 200 the keyboard of the present invention with the rows at different vertical heights and the keys narrowed at the end towards the user. Notice that you can actually still see a portion of the letter “K” key 203 when typing using the keyboard 200 (and importantly you can see adjacent keys “J” and “L” in the same row clearly) while you cannot even see the adjacent keys are when typing on the Prior Art keyboard 2001.

FIG. 7 is a side (longitudinal) view of a keypad 220 of the present invention in which the vertical differential between the planes of the different rows is accomplished by using key tops 226 of differing thicknesses for each row. The keypad 220 has a planar key support 224 on which are arranged a plurality of keys 226 in first 231, second 232, third 233 and fourth 234 parallel rows aligned with the lateral axis of the keypad 220. The keys 226 in each row are spaced evenly and comprise a key top 230 and a key actuation mechanism 228. The layout of the keys 226, the electrical wiring and all the components except the key tops 230 can be identical to that of any prior art keyboard of any size. The key tops 241, 242, 243 and 244 of the keypad 220 have the same horizontal cross-sectional dimensions as the prior art key tops.

The keys 226 in the first row 231 have a first key top 241, in the second row 232 have a second key top 242, in the third row 233 have a third key top 243, and in the fourth row 234 have a fourth key top 244. The key tops 241, 242, 243 and 244 have a dimension height 246 measured along the keys 226 vertical axis from the bottommost edge 247 of the key top 230 to the topmost edge 249 of the key top 230. The first key top 241 has a first vertical dimension 251. The second key top 242 has a second vertical dimension 252 that is greater than the first vertical dimension 251. The third key top 243 has a third vertical dimension 253 that is greater than the second vertical dimension 252. The fourth key top 244 has a fourth vertical dimension 254 that is greater than the third vertical dimension 253. The resulting keyboard has keys 226 in rows of ever increasing height as the rows get further from the user in the longitudinal direction. This embodiment of the present invention enables one to convert any prior art keyboard into a keyboard of the present invention merely by swapping the standard single-height keys of the prior art keyboard for sets of key tops 230 of different heights.

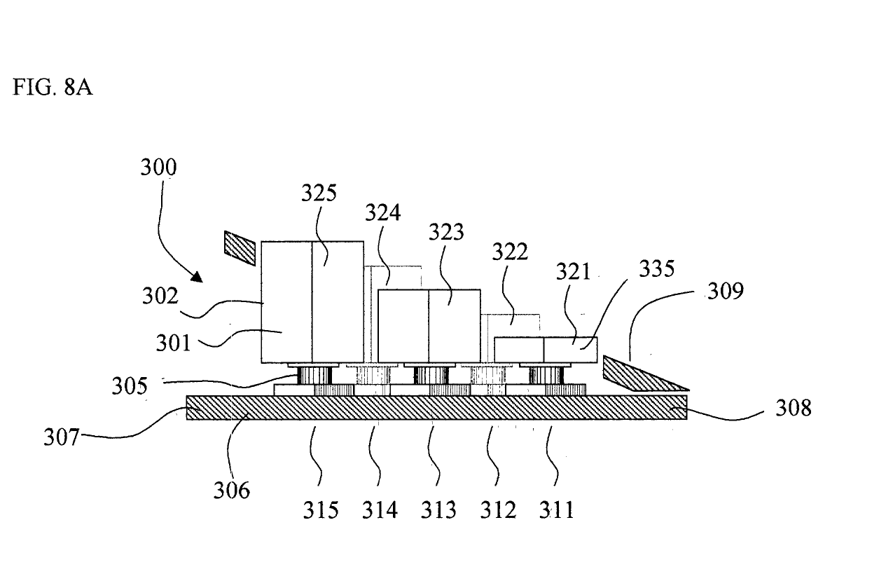

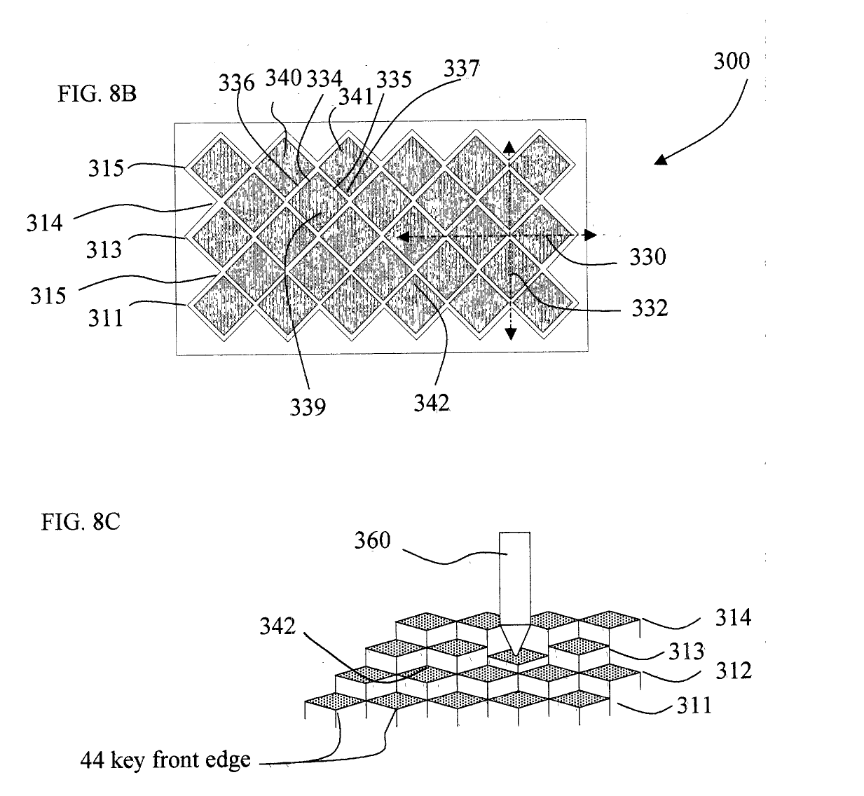

FIGS. 8A, 8B and 8C three views of the same embodiment of a keypad of the present invention which is a variation of the keypad 300 in FIG. 7 with key tops of multiple heights. As with drawings of other embodiments already discussed, the figures show the basic design of the keypad which can be applied to a keypad of any layout and type. The keypad 300 consists of twenty-eight keys 302 arranged in two rows of five keys each nested between three rows of six keys each on a key support 306. FIG. 8A shows a longitudinal side view of the keys 302 are laid out in first 311, second 312, third 313, fourth 314 and fifth 315 rows of keys 302 aligned with the lateral axis of keypad 300. The keys 302 comprise a key actuation mechanism 305 and a key top 301. The key tops 301 are square but the keys 302 are rotated ninety degrees so that the key tops 301 appear to be a diamond shape when viewed from the longitudinally or laterally. The keys 302 in the first row 311 have a first key top 321, the keys 302 in the second row 312 have a second key top 322, the keys 302 in the third row 313 have a third key top 323, The keys 302 in the fourth row 314 have a fourth key top 324, and the keys 302 in the fifth row 315 have a fifth key top 325. The key tops 301 have a vertical dimension (as shown in FIG. 7) and the vertical dimension of the fifth key top 325 is greater than that of the fourth key top 324 which is greater than that of the third key top 323 which is greater than that of the second key top 322 which is greater than that of the first key to 321 to create a set of five staggered rows with heights increasing from the front 308 of the keypad 300 to the back 307 of the keypad 300. An optional cover 309 has the same incline as a plane intersecting all the keys at the center of the top of the keys.

FIG. 8B is a top view of the keypad 300. The key tops have four vertical sides, and have a longitudinal axis 332 and a lateral axis 330. Adjacent keys 302 in the same row are aligned along their lateral axes while keys in alternating rows are aligned along their longitudinal axes. The second 312 and fourth 314 rows are nested between the first 31 1, third 313 and fifth 315 rows such that the back faces 334 & 335 of a key 339 in a nested row are in contact with the right-oriented front face 336 of the key 340 in the next row back to the immediate left and the left-oriented front face 337 of the key 341 in the next row back to its immediate right. The same is true of all keys except those in the fifth row 315. The key tops 321, 322, 323, 324 & 325 are sized so that there is a minimal gap between their adjacent faces. The height differential between the faces of a nested key and the adjacent keys in the row immediately behind create two-walled corner 342 at the back of each nested key (see FIG. 8C also for perspective view). FIG. 8C is a perspective view of the keypad of FIGS. 8A & 8B, and clearly shows the advantage of this embodiment. The corner 242 provides a “trap” for a stylus 360 while the diamond shape of the key top 301 has the same advantage that the key top 190 conferred on the keypad 195 in FIG. 5B and the keypad 200 in FIG. 6, that of increasing the effective separation of the keys to make inadvertent multiple key strikes easier to avoid.

Standard key actuation mechanisms can be used for the keypad 300 simply by rotating the key mechanism forty-five degrees.

FIG. 15 shows an embodiments of the present invention as peripheral devices for portable electronic device 70, which could be a handheld computer, PDA or other portable electronic device).

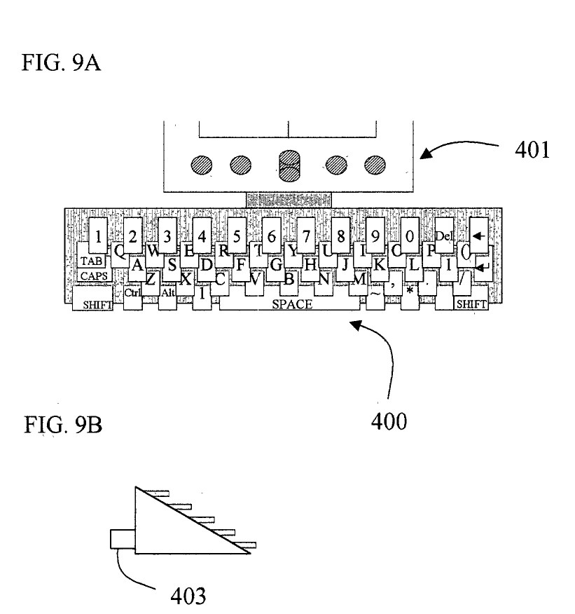

FIG. 9A is for illustrative purposes and shows a low-aspect ratio peripheral keyboard 400 of the present invention for attachment to a PDA or handheld computer 401 through the hot sync port. Note that the keyboard 400 is significantly wider will therefore be easier to type, yet is not much bigger than existing peripherals. The keyboard 200 of FIG. 6 could easily be made into a peripheral keyboard that would be one-half the size of the Palm Mini Keyboard peripheral. FIG. 9B is a side view stylized silhouette of the keyboard 400 for illustrative purposes.

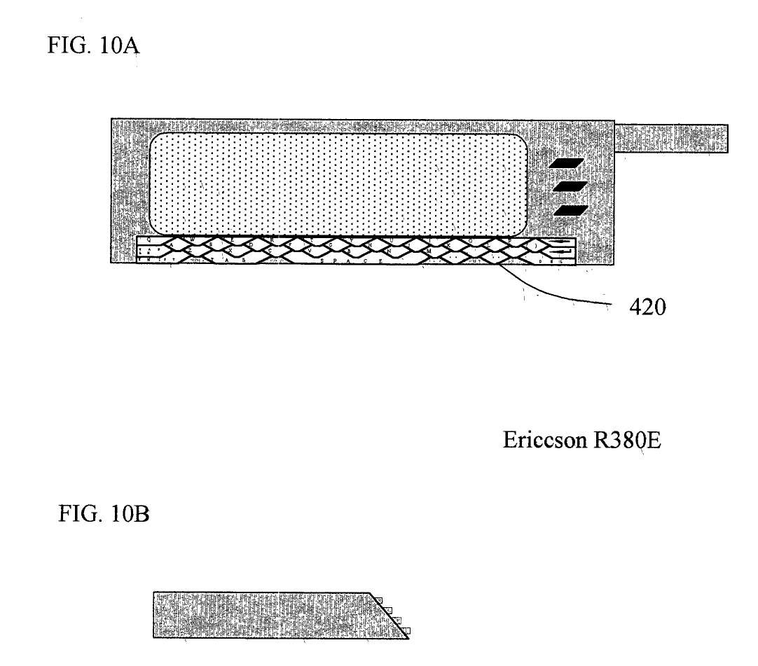

FIG. 10A is a keyboard of the present invention incorporated into the long side of a cell phone/PDA combination such as the Ericcson R380E showing how the vertically staggered rows, low-aspect ratio and pointed keys of the present invention make it possible to incorporate a usable keyboard in a place where no prior art keyboard could possible fit, nor would any keyboard designer even consider doing so.

What is claimed is:

1. A keyboard, comprising:
a. a board containing a plurality of actuator buttons each of which corresponds with an Ascii character;
b. a first set of keys movable into and out of engagement with corresponding ones of said plurality of actuator buttons along a first set of respective vertically extending axes, and extending in a common first plane and in a first row defined by a common first longitudinal axis
c. a second set of keys movable into and out of engagement with corresponding ones of said plurality of actuator buttons along a second set of respective vertically extending axes, and extending in a common second plane vertically spaced from said first plane, and in a second row defined by a common second longitudinal axis that is parallel to said first longitudinal axis;
d. a plurality of said second set of keys being positioned in nested relation to corresponding ones of said first set of keys, whereby movement of one of said second set of keys is bounded by at least one of said first set of keys.

2. A keyboard, comprising:
a. a board containing a plurality of actuator buttons each of which corresponds with an Ascii character;
b. a first set of keys movable into and out of engagement with corresponding ones of said plurality of actuator buttons along a first set of respective vertically extending axes, and extending in a common first plane and in a first row defined by a common first longitudinal axis; and
c. a second set of keys movable into and out of engagement with corresponding ones of said plurality of actuator buttons along a second set of respective vertically extending axes, and extending in a common second plane vertically spaced from said first plane, and in a second row defined by a common second longitudinal axis that is parallel to said first longitudinal axis.

3. A keyboard, comprising:
a. first, second, and third sets of keys aligned in first, second, and third rows, respectively, that extend along first, second, and third longitudinal axes, respectively, wherein said second row extends between said first and third rows, and each of said keys in said first, second, and third sets of keys include respective leading and trailing edges and respective geometric centers;
b. an aspect ratio defined by the lateral distance separating the trailing edge of a key in said first set of keys from the leading edge of a key in said third set of keys, to the lateral distance separating the closest edge of a first and a second key separated by a single third key in the same of any of said first, second and third rows; and
c. said aspect ratio being no greater than 2 to 3.

4. A keyboard, comprising:
a. first, second, and third sets of keys aligned in first, second, and third rows, respectively, that extend along first, second, and third longitudinal axes, respectively, wherein each of said keys in said first, second, and third sets of keys include first, second, and third heights, respectively;
b. said first height being less than said second and third heights; and said second height being less than said third height.
